(19) United States
(12) Patent Application Publication
(10) Pub. No.: US 2022/0221415 A1
(43) Pub. Date: Jul. 14, 2022

(54) SENSOR ASSEMBLY AND CONTROL METHOD THEREOF

(71) Applicant: LG ELECTRONICS INC., Seoul (KR)

(72) Inventors: Masaki TAKADA, Tokyo (JP); Katsuyoshi HIRAKI, Tokyo (JP); Osamu SATO, Tokyo (JP); Sungmin KANG, Tokyo (JP)

(21) Appl. No.: 17/613,223

(22) PCT Filed: Jan. 20, 2020
(86) PCT No.: PCT/KR2020/000917

§ 371 Date: Nov. 22, 2021

(30) Foreign Application Priority Data
May 23, 2019 (KR) 10-2019-0060820

(51) Int. Cl. G01N 27/12; G01K 7/16

(52) U.S. Cl. CPC G01N 27/122; G01K 7/16

(57) ABSTRACT

The present disclosure relates to a sensor assembly and a control method therefor. The sensor assembly according to the present disclosure may include a plurality of gate lines, at least one detection line, and a plurality of sensors respectively disposed at portions where the plurality of gate lines intersect with the at least one detection line. In this case, the plurality of sensors include an olfactory sensor, a temperature sensor, and a humidity sensor.

### TECHNICAL FIELD

The present disclosure relates to a sensor assembly and a control method therefor.

### BACKGROUND ART

Recently, research on human five senses has been actively conducted, and technical implementation of human five senses is being continuously developed. In particular, development of a technology that mimics the human sense of smell is being developed. Specifically, an olfactory sensor that detects and analyzes chemical components of odors is being developed.

The olfactory sensor may collect information on substances constituting the odor, and identify the type, concentration, and characteristics of the odor through the information. That is, the olfactory sensor may identify odor like a human. Through this, it is possible to determine whether a substance harmful to the human body or food is spoiled.

In addition, when a person is exposed to a specific odor for a long time, the person becomes accustomed to the odor and has trouble smelling other odors. Accordingly, the olfactory sensor may replace the odor of a person who is easily fatigued. In addition, the olfactory sensor may accurately detect even a very small amount of odor substances that are difficult for humans to distinguish.

In this case, the olfactory sensor may be affected by temperature and humidity. In particular, when the concentration of odor particles or gas particles detected by the olfactory sensor is low, the temperature and humidity may be more affected. Accordingly, the olfactory sensor may require calibration according to changes in temperature and humidity.

In relation to the olfactory sensor considering the changes in temperature and humidity, the following prior document has been published.

1. Japanese Laid-Open Patent: JP2004-93241 (Published date: Nov. 6, 2003)

2. Title of invention: Gas sensor characteristic compensator and gas concentration measuring device

The prior document relates to an invention considering changes in temperature and humidity of a gas sensor, which is a type of olfactory sensor. In detail, the prior document disclosures a technique of arranging a humidity sensor and a temperature sensor in the vicinity of the gas sensor, and calibrating a value measured by the gas sensor using the humidity and temperature values obtained therefrom.

In this case, the prior document disclosures a gas sensor, a humidity sensor and a temperature sensor as separate devices. Accordingly, there is a problem in that the installation and maintenance of each sensor device need to be separately performed. In addition, there is a problem in that it is impossible to downsize and integrate the entire device.

In addition, the gas sensor, the humidity sensor, and the temperature sensor provided as separate devices are physically separated from each other. Accordingly, there is a problem in that the temperature and humidity values that affect the result value of the gas sensor cannot be accurately measured.

In detail, there is a possibility that the humidity and temperature of the gas sensor and the humidity and temperature of a space in which the humidity sensor and the temperature sensor are installed are different from each other. Accordingly, there is a problem in that it is difficult to obtain an accurate value even when a value measured by the gas sensor is calibrated based on humidity values and temperature values of different spaces.

### DISCLOSURE

### Technical Problem

The present disclosure has been proposed to solve this problem, and an object of the present disclosure is to a sensor assembly including an olfactory sensor, a humidity sensor and a temperature sensor in one installation space to output an olfactory value, a humidity value, and a temperature value together, and a control method therefor.

In particular, an object of the present disclosure is to provide a sensor assembly capable of calibrating and outputting an olfactory value using a humidity value and a temperature value installed in a same installation space to output a relatively accurate olfactory value, and a control method therefor.

### Technical Solution

A sensor assembly according to the spirit of the present disclosure is configured as a single device in which an olfactory sensor, a humidity sensor, and a temperature sensor are arranged.

In particular, the olfactory sensor, the humidity sensor, and the temperature sensor may be respectively disposed at portions where a plurality of gate lines intersect with at least one detection line. That is, the olfactory sensor, the humidity sensor, and the temperature sensor may be arranged in a matrix form.

In detail, the sensor assembly according to the present disclosure may include a plurality of gate lines, at least one detection line extending to intersect with the plurality of gate lines, and a plurality of sensors respectively disposed at positions where the plurality of gate lines intersect with the at least one detection line.

In addition, the plurality of sensors may include an olfactory sensor provided with a sensing material whose resistance value changes according to an odor component, a temperature sensor provided with a sensing material whose resistance value changes according to a change in temperature, and a humidity sensor provided with a sensing material whose resistance value changes according to a change in humidity

In addition, the plurality of sensors may include a plurality of olfactory sensors and a single temperature sensor and a humidity sensor.

In addition, the plurality of sensors may include a plurality of olfactory sensors, a plurality of temperature sensors, and a plurality of humidity sensors.

On the other hand, a reaction value of the olfactory sensor, a reaction value of the temperature sensor, and a reaction value of the humidity sensor can be more easily obtained together through the control method for the sensor assembly according to the spirit of the present disclosure.

In addition, it is possible to obtain a more accurate olfactory value by calibrating the reaction value of the olfactory sensor using the reaction value of the temperature sensor and the reaction value of the humidity sensor.

In detail, in the control method for the sensor assembly according to the present disclosure, the [1,1] sensor to the [n, m] sensor disposed at portions where n gate lines (n is a natural number greater than 1) intersect with m detection lines (m is a natural number greater than 1) are included.

The sensing material included in at least one of the [1,1] sensor to the [n,m] sensor may react such that a resistance value is changed according to a change in temperature.

Further, the sensing material included in at least one of the [1,1] sensor to the [n,m] sensor may react such that a resistance value is changed according to a change in humidity.

Further, the sensing material included in at least one of the [1,1] sensor to the [n,m] sensor may react such that a resistance value is changed according to an odor component.

As a result, the temperature value, the humidity value, and the olfactory value may be output together through the reaction value.

In addition, the reaction value according to the resistance value changed according to the odor component is calibrated with the reaction value according to the resistance value changed according to the change in temperature and the reaction value according to the resistance value changed according to the change in humidity and output as the olfactory value.

### Advantageous Effects

According to the embodiments of the present disclosure, there is an advantage that the olfactory sensor, the temperature sensor, and the humidity sensor can be controlled and managed through a single sensor assembly.

In addition, since the olfactory sensor, the temperature sensor, and the humidity sensor are respectively disposed at portions where a plurality of gate lines intersect with at least one detection line, there is an advantage in that a detected value can be obtained through relatively easy control.

In addition, there is an advantage in that a more accurate olfactory value can be obtained by calibrating a value detected by the olfactory sensor using the values detected by the temperature sensor and the humidity sensor.

In particular, since the olfactory sensor, the temperature sensor, and the humidity sensor are provided in one device and are physically located very closely, there is an advantage in that temperature and humidity can be calibrated more accurately.

In addition, since the temperature sensor and the humidity sensor are provided singly and rest sensors are all provided as olfactory sensors, there is an advantage that more accurate olfactory value can be derived through the greater number of olfactory sensors.

In addition, since the olfactory sensor, the temperature sensor, and the humidity sensor are all provided in plurality to derive an average value of the detected values, there is an advantage that a temperature value, a humidity value and an olfactory values can be obtained more accurately.

### DESCRIPTION OF DRAWINGS

FIG. 1 is a view illustrating a refrigerator in which a sensor assembly is installed according to an embodiment of the present disclosure.

FIG. 2 is a diagram schematically illustrating a main configuration of a sensor assembly according to an embodiment of the present disclosure.

FIG. 3 is a diagram illustrating a minimum unit of a sensor assembly according to an embodiment of the present disclosure.

FIGS. 4 and 5 are diagrams illustrating a sensor assembly according to an embodiment of the present disclosure.

FIG. 6 is a diagram illustrating a control flow of a sensor assembly according to an embodiment of the present disclosure.

FIG. 7 is a diagram illustrating an output value of a sensor assembly according to an embodiment of the present disclosure.

FIG. 8 is a diagram illustrating a sensor arrangement of a sensor assembly according to a first embodiment of the present disclosure.

FIG. 9 is a diagram illustrating a sensor arrangement of a sensor assembly according to a second embodiment of the present disclosure.

FIG. 10 is a diagram illustrating a sensor arrangement of a sensor assembly according to a third embodiment of the present disclosure.

### MODE FOR INVENTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. It should be noted that if it is described in the specification that one component is “connected,” “coupled” or “joined” to another component, the former may be directly “connected,” “coupled,” and “joined” to the latter or “connected”, “coupled”, and “joined” to the latter via another component.

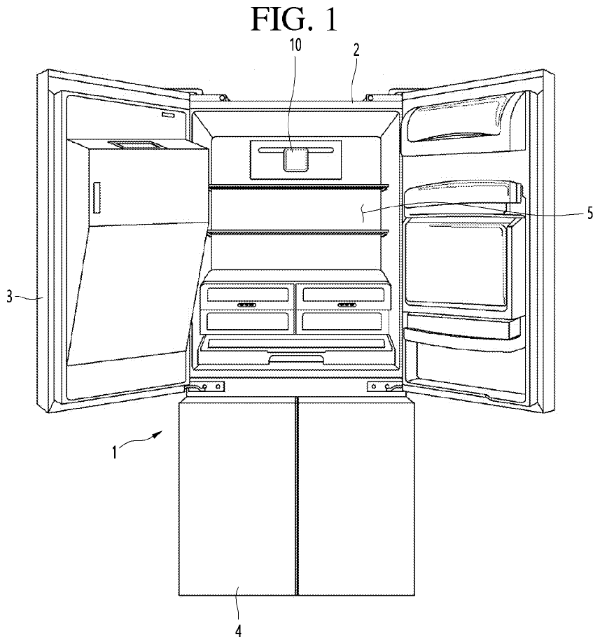

FIG. 1 is a view illustrating a refrigerator in which a sensor assembly is installed according to an embodiment of the present disclosure.

As shown in FIG. 1, a sensor assembly 10 according to the spirit of the present disclosure may be installed in a refrigerator 1.

<Installation Example: Refrigerator>

The refrigerator 1 may include a cabinet 2 forming an outer shape and refrigerator doors 3 and 4 movably connected to the cabinet 2.

A storage compartment in which food is stored may be formed inside the cabinet 2. The storage compartment may include a refrigerating compartment 5 and a freezing compartment located below the refrigerating compartment 5. In general, the freezing compartment may be maintained at a lower temperature than that of the refrigerating compartment 5.

That is, the refrigerator 1 illustrated in FIG. 1 may correspond to a bottom freezer type refrigerator in which a refrigerating compartment is disposed above a freezing compartment. This is an example, and the refrigerator 1 may be provided as a top mount type refrigerator in which a freezing compartment is disposed above a refrigerating compartment, a side by side type refrigerator in which a freezing compartment and a refrigerating compartment are partitioned into left and right sides by a partition wall, or the like.

The refrigerator doors may include a refrigerating compartment door 3 for opening and closing the refrigerating compartment 5 and a freezing compartment door 4 for opening and closing the freezing compartment. Each of the refrigerator compartment door 3 and the freezing compartment door 4 may include a plurality of doors arranged left and right.

Also, the refrigerating compartment door 3 and the freezing compartment door 4 may be rotatably coupled to the cabinet 2. This is exemplary, and the refrigerating compartment door 3 and the freezing compartment door 4 may be coupled to the cabinet 2 in various shapes and numbers.

In this case, the sensor assembly 10 may be disposed on one side of the refrigerating compartment 5. In detail, the sensor assembly 10 may be installed in an inner wall forming the refrigerating compartment 5. Accordingly, the sensor assembly 10 may output a physical value corresponding to the interior of the refrigerating compartment 5.

In particular, the sensor assembly 10 according to the spirit of the present disclosure may output a temperature value, a humidity value, and an olfactory value. In this case, the temperature value, the humidity value, and the olfactory value may mean a physical quantity for temperature, a physical quantity for humidity, and a physical quantity for smell, respectively.

For example, the sensor assembly 10 may measure a temperature value, a humidity value, and an olfactory value corresponding to the interior of the refrigerating compartment. In this case, the olfactory value may correspond to a specific smell generated inside the refrigerating compartment 5.

For example, the sensor assembly 10 may determine the smell of spoiled food. That is, the sensor assembly 10 may detect that food stored in the refrigerating compartment 5 is spoiled. Through such information, a user may store and manage food in the refrigerator 1 more conveniently.

In this case, the arrangement of the sensor assembly 10 as shown in FIG. 1 is merely exemplary. That is, the sensor assembly 10 may be installed in any place to measure a temperature value, a humidity value, and an olfactory value.

Hereinafter, a configuration of the sensor assembly 10 will be described in detail.

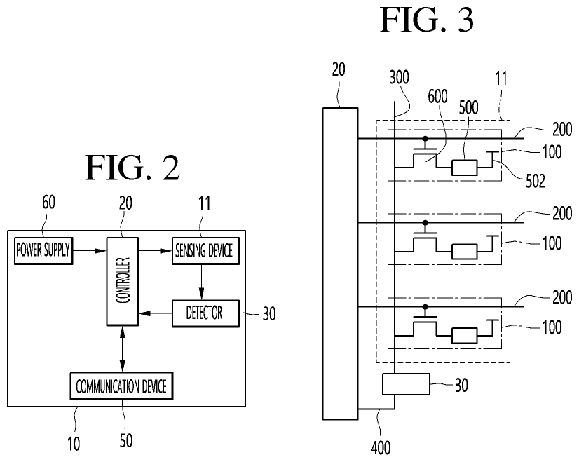

FIG. 2 is a diagram schematically illustrating a main configuration of a sensor assembly according to an embodiment of the present disclosure.

As shown in FIG. 2, the sensor assembly 10 may include a sensing device 11, a controller 20, and a detector 30.

The sensing device 11 may be configured to sense a predetermined temperature, humidity, and smell. In detail, the sensing device 11 may have a configuration in which a sensing material having a resistance value that changes according to a predetermined temperature, humidity, and smell is disposed.

The controller 20 may control the operation of the sensing device 11. In particular, the controller 20 may be provided to control the operation of at least a part of the sensing device 11. Accordingly, the controller 20 may determine a sensing timing by the the sensing device 11.

Also, the controller 20 may be connected to a predetermined power supply 60. The power supply 60 may transmit the sensing timing by the sensing device 11 to the controller 20. For example, the power supply 60 may be a device which may be operated by a user. Accordingly, the controller 20 may control the operation of the sensing device 11 according to the user's request.

The detector 30 may be configured to detect information on smell detected by the sensing device 11. In detail, the detector 30 may be a circuit that measures a change in the resistance value transmitted from the sensing device 11. In addition, the detector 30 may transmit the detected information to the controller 20.

Also, the controller 20 may directly or indirectly analyze the information transmitted from the detector 30. For example, the controller 20 may transmit the information transmitted from the detector 30 to an external device through a communication device 50. In this case, the external device may be a mobile device used by the user or a home network.

In summary, the sensing device 11 may be operated by the controller 20, and the detector 30 may detect predetermined information from the sensing device 11. Then, the controller 20 may receive the predetermined information from the detector 30.

The configuration of the sensor assembly 10 is exemplary, and some components may be omitted or added. In particular, essential components in the sensor assembly 10 according to the spirit of the present disclosure may be the sensing device 11, the controller 20, and the detector 30.

Hereinafter, the configuration of the sensing device 11 and the connection relationship between the sensing device 11, the controller 20 and the detector 30 will be described in detail.

FIG. 3 is a diagram illustrating a minimum unit of a sensor assembly according to an embodiment of the present disclosure.

As shown in FIG. 3, the sensing device 11 may include a plurality of sensors 100.

The sensor 10 may include a sensing material 500. The sensing material 500 may be understood as having a configuration in which a resistance value changes according to temperature, humidity, and smell. For example, the sensing material 500 may be an inorganic material, an organic material, or a composite material of an inorganic material and an organic material. For example, the organic material may be a conductive polymer or an organic semiconductor. In addition, the inorganic material may be a metal oxide semiconductor, a compound semiconductor, or a semiconductor made of a single chemical element. That is, the sensing material 500 may include various types of materials.

Further, one sensor 100 may include one sensing material 500. That is, the sensing device 11 may include a plurality of sensing materials 500 corresponding to the number of the sensors 100. Referring to FIG. 3, three sensors 100 and three sensing materials 500 respectively included in the three sensors 100 are shown.

In this case, when the sensing material 500 is a material whose resistance value changes according to a change in temperature, the sensor 100 in which the sensing material 500 is installed may be understood as a temperature sensor. In addition, when the sensing material 500 is a material whose resistance value changes according to a change in humidity, the sensor 100 in which the sensing material 500 is installed may be understood as a humidity sensor. In addition, when the sensing material 500 is a material whose resistance value changes according to an odor component, the sensor 100 in which the sensing material 500 is installed may correspond to an olfactory sensor.

The sensor assembly 10 according to the spirit of the present disclosure may include a temperature sensor, a humidity sensor, and an olfactory sensor. That is, the plurality of sensors 100 may include a temperature sensor, a humidity sensor, and an olfactory sensor. Accordingly, the three sensors 100 shown in FIG. 3 may correspond to a temperature sensor, a humidity sensor, and an olfactory sensor, respectively.

In addition, the sensor 100 may include a sensing material power supply (VDD, Voltage Drain Drain) (502) for supplying power to the sensing material 500.

In addition, the sensing device 11 may include a gate line 200 connected to the controller 20. In addition, the sensing device 11 includes a detection line 300 connected to the detector 30. The sensor 100 is connected to the gate line 200 and the detection line 300.

In this case, the sensor 100 may include a transistor 600. The transistor 600 may correspond to a component for switching the connection between the sensing material 500 and the detection line 300. In particular, the transistor 600 may be a thin film transistor (TFT).

In addition, the transistor 600 may be controlled by the controller 20. In detail, the controller 20 transmits a predetermined control signal to the transistor 600 through the gate line 200. In addition, the transistor 600 connects the detection line 300 and the sensing material 500 according to a corresponding control signal.

In this case, the controller 20 includes a shift register (not shown) that sequentially transmits control signals to the gate lines 200. That is, the controller 20 may sequentially transmit control signals to the plurality of gate lines 200. In this case, the number and order of the gate lines 200 to which the controller 20 sequentially transmits control signals may be predetermined.

In summary, the sensing device 11 may include the sensor 100, the gate line 200, and the detection line 300. Also, the sensor 100 may be installed at a portion where the gate line 200 and the detection line 300 intersect so as to be connected to both the gate line 200 and the detection line 300.

In addition, as described above, the sensing device 11 may be provided with the plurality of sensors 100. Accordingly, at least one of the gate line 200 and the detection line 300 may be provided in plurality.

Referring to FIG. 3, in order to install three sensors 100, three or more intersections between the gate line 200 and the detection line 300 needs to be provided. Accordingly, three gate lines 200 may be provided so that the three sensors 100 may be installed.

In addition, the sensor assembly 10 may include a transmission line 400 connecting the controller 20 and the detector 30. Data detected by the detector 30 may be transmitted through the transmission line 400.

FIG. 3 shows an example in which the sensing device 11 is designed in a minimum unit. In detail, a structure in which a single temperature sensor, a single humidity sensor, and a single olfactory sensor are provided is shown. This is only an example of the sensing device 11 and the sensing device 11 is not limited thereto. Hereinafter, the configuration of the sensing device 11 will be described in detail.

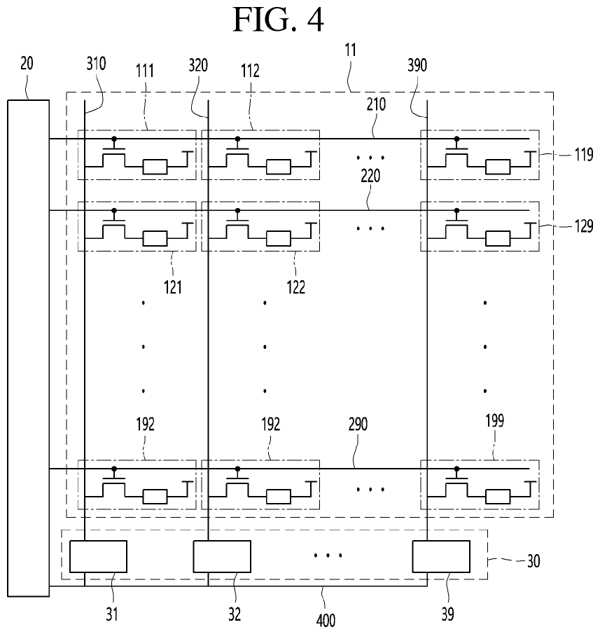

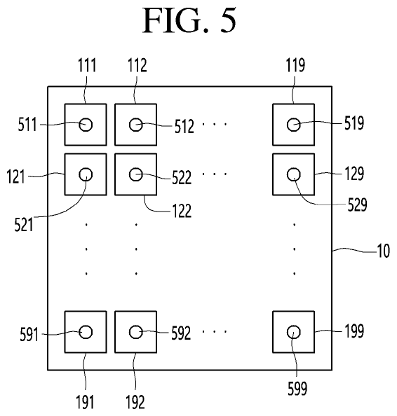

FIGS. 4 and 5 are diagrams illustrating a sensor assembly according to an embodiment of the present disclosure. FIGS. 4 and 5 are schematic diagrams for convenience of understanding, and may be different from an actual sensor assembly.

In detail, FIG. 4 shows a general sensor assembly in the form of a circuit corresponding to FIG. 3. FIG. 5 schematically shows a sensor and a sensing material in FIG. 4.

As shown in FIG. 4, the sensing device 11 may include n gate lines 200 and m detection lines 300. In this case, n is a natural number greater than 1, and m is a natural number greater than or equal to 1. Although n and m are illustrated as being 3 or more in FIGS. 4 and 5, this is illustrated for convenience of description and is not limited thereto.

Hereinafter, the n gate lines 200 are expressed as a first gate line 210 and a second gate line 220 to an n-th gate line 290. In this case, the first gate line 210 may be understood as a gate line that first receives a signal from the controller 20. Also, the second gate line 220 may be understood as a gate line that receives a signal subsequently to the first gate line 210.

That is, the first gate line 210, the second gate line 220 to the n-th gate line 290 may be understood as the order in which signals are received from the controller 20. Also, for convenience of understanding, the first gate line 210 and the second gate line 220 to the n-th gate line 290 are sequentially illustrated.

In addition, the m detection lines 300 are expressed as a first detection line 310, and a second detection line 320 to an m-th detection line 390. In addition, the first detection line 310, and the second detection line 320 to the m-th detection line 390 may be individually connected to the detector 30.

The detector 30 may include a plurality of detection circuits. The detection circuit may be understood as a circuit for detecting a value that is changed according to the resistance value of the sensing material 500.

In detail, the detection circuit may include a detection resistor and a converter (A/D Converter, ADC). A voltage value Vadc may be changed according to the resistance value of the sensing material 500, and the changed value may be detected by the converter. That is, data according to temperature, humidity, and smell sensed by the sensing material 500 may be output.

In this case, the detector 30 may include a number of detection circuits corresponding to the number of detection lines 300. In other words, one detection circuit may be installed in one detection line 300. That is, the detector 30 may include m detection circuits corresponding to the m detection lines 300.

Accordingly, the plurality of detection circuits may be divided into a first detection circuit 31 and a second detection circuit 32 to an m-th detection circuit 39. And, as shown in FIG. 4, each detection line 300 and each detection circuit may be connected to each other in correspondence with each other. That is, the first detection line 310 may be connected to the first detection circuit 31, and the second detection line 320 may be connected to the second detection circuit 32.

In addition, the first detection circuit 31, and the second detection circuit 32 to the m-th detection circuit 39 may be connected to the transmission line 400. That is, data detected by the first detection circuit 31, and the second detection circuit 32 to the m-th detection circuit 39 may be transmitted to the controller 20.

As described above, the sensor 100 may be connected to the gate line 200 and the detection line 300. In other words, the sensor 100 may be arranged at a point where the gate line 200 and the detection line 300 intersect with each other.

As shown in FIG. 4, the n gate lines 200 extends in the horizontal direction and are arranged to be spaced apart from each other in a vertical direction. In addition, the m detection lines 300 extend in the vertical direction and are arranged to be spaced apart from each other in a horizontal direction. As a result, the gate line 200 may form a row and the detection line 300 may form a column, so that a kind of matrix structure may be formed.

In detail, the first detection line 310 to the m-th detection line 390 may be sequentially arranged on the first gate line 210 in the horizontal direction. In addition, the second gate line 220 to the n-th gate line 290 may be sequentially arranged in the vertical direction to intersect with the first detection line 310 to the m-th detection line 390.

As shown in FIGS. 4 and 5, the sensors 100 may be arranged at points where the first gate line 210 to the n-th gate line 290 intersect with and the first detection line 310 to the m-th detection line. As a result, the sensors 100 may be arranged in the horizontal direction and the vertical direction.

Accordingly, n*m sensors 100 may be installed in the sensing device 11. In this case, each sensor is named according to the numbers of the gate line and the detection line to which the sensor is to be coupled. For example, a sensor coupled to the first gate line 210 and the first detection line 310 is referred to as a [1,1] sensor 111. In addition, a sensor coupled to the n-th gate line 290 and the m-th detection line 390 is referred to as a [n,m] sensor 199.

Accordingly, it may be understood that the [1,1] sensor 111 and the [1,2] sensor 112 to the [1,m] sensor 119 are sequentially arranged on the first gate line 210. In addition, it may be understood that the [1,1] sensor 111 and the [2,1] sensor 121 to the [n,1] sensor 191 are sequentially arranged on the first detection line 310.

However, according to the arrangement of the sensors, more than n*m sensors may be installed in the sensing device 111. For example, a pair of sensors connected to different gate lines may be arranged to be connected to one detection line. Accordingly, n*m*2 sensors may be installed in the sensing device 11.

Hereinafter, for convenience of description, a case in which a number of sensors are provided which corresponds to the number of the gate lines and the number of the detection lines will be described. That is, a case in which n gate lines, m detection lines, and n*m sensors are provided will be described.

In addition, as described above, one sensor 100 may include one sensing material 500. That is, the sensing device 11 may include the same number of sensors 100 and sensing materials 500.

In this case, the sensing material is named so as to correspond to each sensor. For example, the sensing material provided in the [1,1] sensor 111 is referred to as a [1,1] sensing material 511. In addition, the sensing material provided in the [n,n] sensor 199 is referred to as a [n,m] sensing material 599.

Hereinafter, the operation of the sensor assembly 10 will be described.

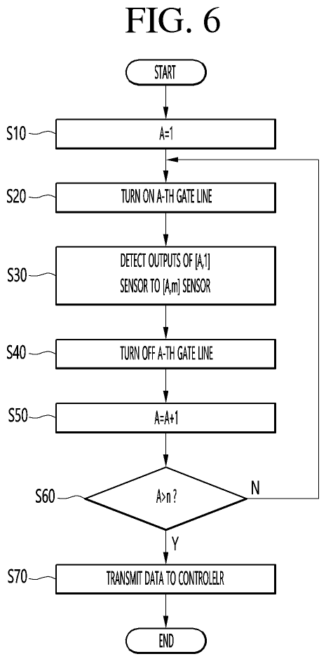

FIG. 6 is a diagram illustrating a control flow of a sensor assembly according to an embodiment of the present disclosure. The operation described in FIG. 6 through the sensor assembly 10 shown in FIGS. 4 and 5 will be described.

As shown in FIG. 6, when the sensor assembly 10 starts to operate, A may be set to 1 (S10). In this case, “A” may be understood as an arbitrary number for distinguishing the gate lines 200. As described above, since the number of gate lines 200 is n, A may be a natural number selected from 1 to n.

Then, the A-th gate line is turned on (S20). In this case, the fact that the A-th gate line is turned on may be understood as a sensor located in the A-th gate line being operated.

In detail, the controller 20 may transmit a control signal through the A-th gate line. That is, the control signal is transmitted to the sensor located on the A-th gate line. In this case, it can be seen that the sensor located on the A-th gate line corresponds to the [A,1] sensor to the [A,m] sensor.

Then, a transistor 600 provided in the [A,1] sensor to the [A,m] sensor may be operated. That is, the sensing materials 500 provided in the [A,1] sensor to the [A,m] sensor may react to generate a predetermined output value.

Since A is set to 1 when the sensor assembly 10 starts to operate, it may be understood that the first gate line 210 is turned on.

Accordingly, the controller 20 may transmit a control signal through the first gate line 210. Then, the control signal may be transmitted to the [1,1] sensor 111 and the [1, 2] sensor 112 to the [1,m] sensor 119 located on the first gate line 210.

Then, the reaction of the [1,1] sensor 111 to the [1,m] sensor 119 may be detected (S30). In detail, the reactions of the [1,1] sensing material 511, the [1,2] sensing material 512 to the [1,m] sensing material 519 may be detected.

In detail, the output values generated by the [A,1] sensor to the [A,m] sensor may be transmitted to the first detection circuit 31 to the m-th detection circuit along the first detection line 310 to the m-th detection line 390. In addition, the first detection circuit 31 to the m-th detection circuit 39 may detect output values generated by the [A,1] sensor to the [A,m] sensor, respectively.

Accordingly, the output values generated by the [1,1] sensor 111 to the [1,m] sensor 119 may be generated by the first detection circuit 31 to the m-th detection circuit 39 along the first detection line 310 to the m-th detection line 390. In addition, the first detection circuit 31 to the m-th detection circuit 39 may detect output values generated by the [1,1] sensor 111 to the [1,m] sensor 119, respectively.

Then, the A-th gate line may be turned OFF (S40). In this case, the fact that the A-th gate line is turned OFF may be understood as operation of the sensor located on the A-th gate line being suspended. That is, the output values generated by the [A,1] sensor to the [A,m] sensor are not transmitted to the first detection line 310 to the m-th detection line 390.

Accordingly, the first gate line 210 may be turned off. Accordingly, the operation of the [1,1] sensor 111 to the [1,m] sensor 119 may be suspended. That is, the output values of the [1,1] sensor 111 to the [1,m] sensor 119 are not transmitted to the first detection line 310 to the m-th detection line 390.

Then, A+1 may be set to A (S50). That is, after obtaining an output value of one gate line, A may be changed to obtain an output value of the next gate line.

Then, it is determined whether A is greater than n (S60). As described above, since A corresponds to one of 1 to n, there is no case where A is greater than n. In other words, since gate lines exist up to the n-th gate line, when A is greater than n, a corresponding gate line no longer exists.

Accordingly, A, which was set to 1, is set to 2, which is a value of 1+1. Further, since n corresponds to a natural number greater than 1, 2 cannot be a number greater than n. Accordingly, as shown in FIG. 6, the second gate line 220 is turned on.

Accordingly, the controller 20 may transmit a control signal through the second gate line 220. Then, the control signal may be transmitted to the [2,1] sensor 121 and the [2, 2] sensor 122 to the [2,m] sensor 129 located on the second gate line 220. Further, the [2,1] sensing material 521, and the [2,2] sensing material 522 to the [2,m] sensing material 529 may react.

Accordingly, the output values generated by the [2,1] sensor 121 to the [2,m] sensor 129 may be generated by the first detection circuit 310 to the m-th detection circuit 390 along the first detection line 310 to the m-th detection line 390. In addition, the first detection circuit 31 to the m-th detection circuit 39 may detect output values generated by the [2,1] sensor 121 to the [2,m] sensor 129, respectively.

Then, the second gate line 220 is turned OFF. Accordingly, the operation of the [2,1] sensor 121 to the [2,m] sensor 129 may be suspended.

Then, A+1 is set to A again, and it is determined whether A is greater than n. Therefore, A, which was set to 2, is set to 3, which is a value of 2+1. For example, a case where n is 2 corresponds to a case where two gate lines 200 are provided. That is, only the first gate line 210 and the second gate line 220 exist, and the first gate line 210 and the second gate line 220 have been turned ON/OFF.

Therefore, there is no longer a gate line capable of being turned ON/OFF.

That is, when A is a value greater than n, it is determined that all gate lines 200 have been turned ON/OFF. In this case, the fact that all gate lines 200 have been turned ON/OFF may mean that the output values of the sensors 100 positioned on a corresponding gate line 200 are detected.

That is, the first gate line 210 is turned ON/OFF, and output values of the [1,1] sensors 111 to [1,m] sensors 119 are detected. Then, the second gate line 220 is turned ON/OFF, and output values of the [2,1] sensors 121 to [1,m] sensors 129 are detected.

As described above, the first gate line 210 to the n-th gate line 290 are subsequently turned ON/OFF, and output values of the [1,1] sensor 111 to the [n,m] sensor 199 are detected.

Accordingly, when “A” is a value greater than n, it means that the output values of the sensors 100 positioned on all the gate lines 200 are detected. That is, when “A” is a value greater than n, it means that the output values of all of the sensors 100 are detected.

Then, data may be transmitted to the controller 20 (S70). In detail, the data detected by the detector 30 may be transmitted to the controller 20 through a transmission line 400.

In this case, such data transmission may be performed immediately after detection of one gate line is completed. That is, the detected values of the [1,1] sensor 111 to the [1,m] sensor 119 may be transmitted to the controller 20 at the same time as the first gate line 210 is turned off.

Accordingly, the controller 20 may receive the detected values of all the sensors 100 disposed in the sensing device 11. In addition, a temperature value, a humidity value, and an olfactory value may be obtained through the detected values. In this case, the olfactory value may be calibrated by a temperature value and a humidity value.

Hereinafter, an output value derived from the sensor assembly 10 will be described.

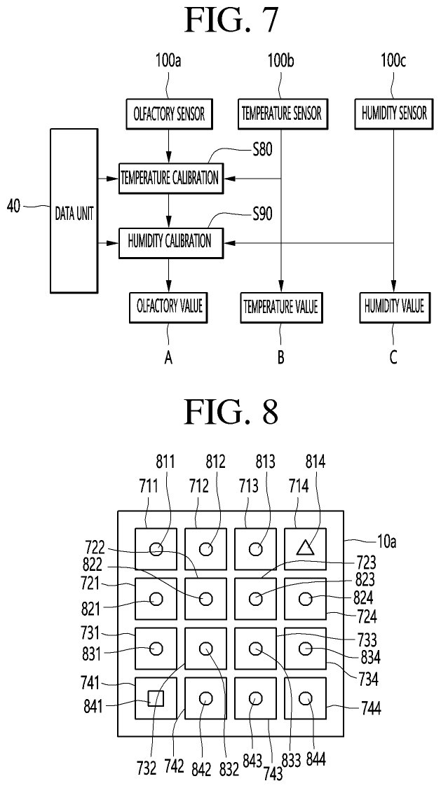

FIG. 7 is a diagram illustrating an output value of a sensor assembly according to an embodiment of the present disclosure.

As shown in FIG. 7, the sensor assembly 10 may include an olfactory sensor 100a, a temperature sensor 100b, and a humidity sensor 100c. As described above, the olfactory sensor 100a, the temperature sensor 100b, and the humidity sensor 100c may be provided with sensing materials 500 for sensing a smell, a temperature and a humidity, respectively.

Further, according to the process shown in FIG. 6, the values detected by the olfactory sensor 100a, the temperature sensor 100b, and the humidity sensor 100c are detected by the detector 30 and sent to the controller 20.

Then, the controller 20 may output a temperature value (B) according to a value sensed by the temperature sensor 100b. Also, the controller 20 may output a humidity value (C) according to a value detected by the humidity sensor 100c. In this case, being output may mean transmitting or displaying a corresponding value to a user or a server.

For example, when the sensor assembly 10 is installed in the refrigerator 1, the detected temperature value (B) and the detected humidity value (C) may be displayed on a display provided in the refrigerator 1.

In this case, the sensor assembly 10 according to the spirit of the present disclosure may calibrate a value detected by the olfactory sensor 100a with values detected by the temperature sensor 100b and the humidity sensor 100c. In fact, the values detected by the temperature sensor 100b and the humidity sensor 100c may also be calibrated according to a predetermined condition, but this will not be described.

The sensor assembly 10 may further include a data unit 40. The data unit 40 may be a component included in the controller 20. The data unit 40 may store data on a change in olfactory value according to a temperature and a humidity.

Accordingly, the controller 20 may calibrate the value detected by the olfactory sensor 100a with the data stored in the data unit 40 and the values detected by the temperature sensor 100b and the humidity sensor 100c. That is, the controller 20 may perform temperature calibration (S80) and humidity calibration (S90) on the value detected by the olfactory sensor 100a.

In this case, the temperature calibration (S80) and the humidity calibration (S90) may be performed simultaneously or sequentially. Accordingly, although it is illustrated in FIG. 7 that the temperature calibration (S80) is performed first and the humidity calibration (S90) is performed, the order is not limited thereto.

Specifically, the controller 20 may derive a calibration value by substituting the value detected by the temperature sensor 100b in the data on a change in olfactory value for a change in temperature stored in the data unit 40. Then, a value detected by the olfactory sensor 100a is calibrated with a calibration value derived from the corresponding data.

As a result, the value detected by the olfactory sensor 100a is subjected to temperature calibration with the value detected by the temperature sensor 100b (S80).

Further, the controller 20 may derive a calibration value by substituting the value detected by the humidity sensor 100c in the data on a change in olfactory value for a change in humidity stored in the data unit 40. Then, a value detected by the olfactory sensor 100a is calibrated with a calibration value derived from the corresponding data.

As a result, the value detected by the olfactory sensor 100a is subjected to humidity calibration with the value detected by the humidity sensor 100c (S90).

As described above, the value detected by the olfactory sensor 100a is output as the olfactory value (A) through the temperature calibration (S80) and the humidity calibration (S90).

In summary, the sensor assembly 10 may integrally output an olfactory value (A), a temperature value (B), and a humidity value (C). In this case, the olfactory value (A) may correspond to a value calibrated by the temperature value (B) and the humidity value (C).

Hereinafter, various examples of the type and arrangement of the sensing materials 500 provided in the sensor 100 will be described. In addition, an analysis method through a value detected according to the type and arrangement of the sensing materials 500 will be described.

FIGS. 8 to 10 are views illustrating a sensor arrangement of a sensor assembly according to an embodiment of the present disclosure. FIGS. 8 to 10 show 16 sensors and 16 sensing materials provided in the sensors. For convenience of description, the number of sensors or sensing materials corresponds to a number set by way of example, and the present disclosure is not limited thereto.

### First Embodiment; Multiple Olfactory Sensors, Single Temperature and Single Humidity Sensor

As shown in FIG. 8, a sensor assembly 10a may include a plurality of sensors 100, and a sensing material 500 may be provided in each of the plurality of sensors 100. In this case, the plurality of sensors 100 may include a plurality of olfactory sensors 100a, a single temperature sensor 100b, and a single humidity sensor 100c.

That is, the sensor assembly 10a may include one temperature sensor 100b and one humidity sensor 100c. The remaining sensors all correspond to the olfactory sensors 100a.

It can be understood that the temperature sensor 100b and the humidity sensor 100c are installed for the temperature calibration (S80) and the humidity calibration (S90). In addition, since the single temperature sensor 100b and the single humidity sensor 100c respectively output a relatively accurate temperature value B and a relatively accurate humidity value C, a large number of sensors may not be required.

Referring to FIG. 8, a [1,1] sensor 711 to a [4,4] sensor 744 are included in the sensor assembly 10a. In addition, the [1,1] sensor 711 to the [4,4] sensor 744 may include one temperature sensor 100b and one humidity sensor 100c. That is, the sensor assembly 10a may include 14 olfactory sensors 100a.

Further, the [1,1] sensor 711 to the [4,4] sensor 744 may include a[1,1] sensing material 811 to a [4,4] sensing material 844, respectively. In this case, for convenience of understanding, the sensing material for detecting a change in resistance value due to humidity is indicated by a triangle, and the sensing material for detecting a change in resistance value due to temperature is indicated by a square. In addition, the sensing material for detecting a change in resistance value according to smell is indicated by a circle.

However, all of the sensing materials shown in FIG. 5 are indicated by circles, but it can be understood that the sensing materials are displayed without distinguishing sensing materials. That is, the sensing materials shown in FIG. 5 does not include only sensing materials for detecting a change in resistance value according to smell.

Accordingly, the [1, 4] sensing material 814 may be a sensing material for detecting a change in resistance value according to humidity. Further, the [4,1] sensing material 841 may be a sensing material for detecting a change in resistance value according to temperature. That is, the [1,4] sensor 714 may correspond to the humidity sensor, and the [4,1] sensor 741 may correspond to the temperature sensor.

In addition, the remaining sensing materials may be sensing materials for detecting a change in resistance value according to smell. That is, the [1,1] sensor 711 to [4,4] sensor 744 except for the [1,4] sensor 714 and the [4,1] sensor 741 may correspond to an olfactory sensor.

In this case, the arrangement of the humidity sensor and the temperature sensor is merely exemplary. That is, the humidity sensor and the temperature sensor may be arranged at different positions.

Referring to FIG. 6, first, the output values of the [1,1] sensor 711, the [1,2] sensor 712, the [1,3] sensor 713 and the [1,4] sensor 714 are detected. Then, the output values of the [2,1] sensor 721, the [2,2] sensor 722, the [2,3] sensor 723 and the [2,4] sensor 724 are detected. Then, the output values of the [3,1] sensor 731, the [3,2] sensor 732, the [3,3] sensor 733 and the [3,4] sensor 734 are detected.

Finally, the output values of the [4,1] sensor 741, the [4,2] sensor 742, the [4,3] sensor 743 and the [4,4] sensor 744 are detected. Then, data corresponding to the output values of the [1,1] sensor 711 to the [4,4] sensor 744 is transmitted to the controller 20.

The controller 20 may output the output value of the [1,4] sensor 714 as a humidity value (C). In addition, the controller 20 may output the output value of the [4,1] sensor 741 as a temperature value (B).

Then, the controller 20 may calibrate the output values of the [1,1] sensor 711 to the [4,4] sensor 744 except for the [1,4] sensor 714 and the [4,1] sensor 741, using the output values of the [1,4] sensor 714 and the [4,1] sensor 741. The calibrated value may be output as the olfactory value (A).

As described above, the sensor assembly 10a may output the olfactory value (A), the temperature value (B), and the humidity value (C). In particular, it is possible to install a larger number of olfactory sensors 100a by providing a single temperature sensor 100b and a single humidity sensor 100c. Accordingly, the sensor assembly 10a may derive an olfactory value with higher measurement and analysis precision.

### Second Embodiment; Multiple Olfactory Sensors, Multiple Temperature Sensors and Multiple Humidity Sensors

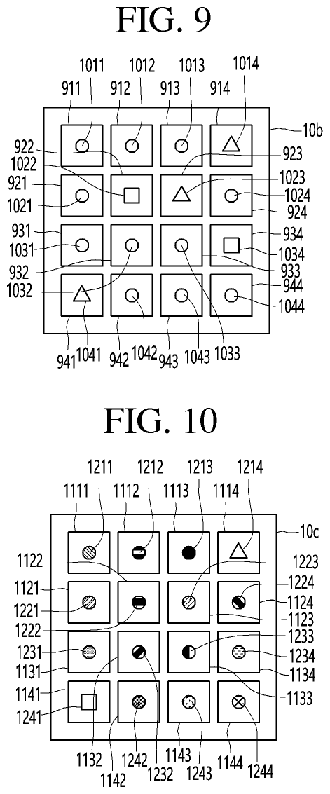

As shown in FIG. 9, a sensor assembly 10b may include a plurality of sensors 100, and each of the plurality of sensors 100 may include a sensing material 500. In this case, the plurality of sensors 100 may include a plurality of olfactory sensors 100a, a plurality of single temperature sensor 100b, and a plurality of single humidity sensor 100c.

In addition, at least one of the temperature sensor 100b and the humidity sensor 100c may be provided in plurality. That is, both the temperature sensor 100b and the humidity sensor 100c may be provided in plurality. Alternatively, the temperature sensor 100b may be provided in plurality, and the humidity sensor 100c may be provided singly. In addition, the humidity sensor 100c may be provided in plurality, and the temperature sensor 100b may be provided singly.

The temperature sensor 100b or the humidity sensor 100c may be provided in plurality to more accurately measure the temperature value (B) and the humidity value (C). In particular, when the sensor assembly 10b includes a relatively large number of sensors 100, the temperature sensor 100b or the humidity sensor 100c may be provided in plurality.

In this case, the number of the temperature sensors 100b and the number of the humidity sensors 100c may be smaller than the number of the olfactory sensor 100a. That is, the sensor assembly 10b may include a greater number of the olfactory sensors 100a than the number of the temperature sensors 100b and the humidity sensors 100c.

In addition, the number of the temperature sensors 100b and the number of the humidity sensors 100c may be set differently according to the needs of the sensor assembly 10b. For example, when the sensor assembly 10b is installed in a place where there is a large change in temperature, a larger number of temperature sensors 100b may be provided in the sensor assembly 10b.

FIG. 9 illustrates a case in which a plurality of temperature sensors 100b and a plurality of humidity sensors 100c are provided in the sensor assembly 10b. In addition, a case where the number of the humidity sensors 100c is greater than the number of the temperature sensors 100b is illustrated. However, this is exemplary and not limited thereto.

Referring to FIG. 9, the sensor assembly 10b may include a [1,1] sensor 911 to a [4,4] sensor 944. In addition, the [1,1] sensor 911 to the [4,4] sensor 944 may include a plurality of temperature sensors 100b, a plurality of humidity sensors 100c, and a plurality of olfactory sensors 100a. That is, the sensor assembly 10a may include two or more temperature sensors 100b, two or more humidity sensors 100c, and two or more olfactory sensors 100a.

Further, the [1,1] sensor 911 to the [4,4] sensor 944 may include a [1,1] sensing material 1011 to a [4,4] sensing material 1044, respectively. In this case, for convenience of understanding, the sensing material for detecting a change in resistance value due to humidity is indicated by a triangle, and the sensing material for detecting a change in resistance value due to temperature is indicated by a square. In addition, the sensing material for detecting a change in resistance value according to smell is indicated by a circle.

Accordingly, the [1,4] sensing material 1014, the [2,3] sensing material 1023, and the [4, 1] sensing material 1041 may be a sensing material for detecting a change in resistance value according to humidity. That is, the [1,4] sensor 914, the [2,3] sensor 923, and the [4,1] sensor 941 may correspond to the humidity sensor. Consequently, the sensor assembly 10b may include three humidity sensors.

Further, the [2,2] sensing material 1022 and the [3,4] sensing material 1034 may be a sensing material for detecting a change in resistance value according to temperature. That is, the [2,2] sensor 922 and the [3,4] sensor 934 may correspond to a temperature sensor. Consequently, the sensor assembly 10b may include two temperature sensors.

In addition, the remaining sensing materials may be sensing materials for detecting a change in resistance value according to smell. That is, the [1,1] sensor 911 to the [4,4] sensor 944 except for the [1,4] sensor 914, the [2,3] sensor 923, the [4,1] sensor 941, the [2,2] sensor 922, and the [3,4] sensor 934 may correspond to olfactory sensors.

Referring to FIG. 6, first, output values of the [1,1] sensor 911, the [1,2] sensor 912, the [1,3] sensor 913 and the [1,4] sensor 914 are detected. Then, the output values of the [2,1] sensor 921, the [2,2] sensor 922, the [2,3] sensor 923 and the [2,4] sensor 924 are detected. Then, the output values of the [3,1] sensor 931, the [3,2] sensor 932, the [3,3] sensor 933 and the [3,4] sensor 934 are detected.

Finally, the output values of the [4,1] sensor 941, the [4,2] sensor 942, the [4,3] sensor 943 and the [4,4] sensor 944 are detected. Then, data corresponding to the output values of the [1,1] sensor 911 to the [4,4] sensor 944 is transmitted to the controller 20.

The controller 20 may output the humidity value (C) through the output values of the [1,4] sensor 914, the [2,3] sensor 923 and the [4,1] sensor 941. For example, the controller 20 may calculate an average value of the output values of the [1,4] sensor 914, the [2,3] sensor 923 and the [4,1] sensor 941 to yield the humidity value (C).

Also, the controller 20 may output the temperature value (B) through the output values of the [2,2] sensor 922 and the [3,4] sensor 934. For example, the controller 20 may output an average value of the output values of the [2,2] sensor 922 and the [3,4] sensor 934 as the temperature value (B).

Further, the controller 20 may calibrate output values of the [1,1] sensor 911 to the [4,4] sensor 944 except for the [1,4] sensor 914, the [2,3] sensor 923, the [4,1] sensor 941, the [2,2] sensor 922 and the [3,4] sensor 934. Then, the calibrated value may be output as the olfactory value (A).

For example, the humidity calibration S90 may be performed through the average value of the output values of the [1,4] sensor 914, the [2,3] sensor 923, and the [4,1] sensor 941. Also, the temperature calibration S80 may be performed through the average value of the output values of the [2,2] sensor 922 and the [3,4] sensor 934.

In this way, the sensor assembly 10b may output the olfactory value (A), the temperature value (B), and the humidity value (C). In particular, it is possible to output a more accurate temperature value (B) and a more accurate humidity value (B) by providing a plurality of temperature sensors 100b and a plurality of humidity sensors 100c. Accordingly, it is possible to output the olfactory value (A) calibrated more accurately.

That is, the sensor assembly 10b may output the more accurate olfactory value (A), the more accurate temperature values (B), and the more accurate humidity values (C).

### Third Embodiment; Different Types of Olfactory Sensors, Temperature Sensors and Humidity Sensors

As shown in FIG. 10, a sensor assembly 10c may include a plurality of sensors 100, and a sensing material 500 is provided in each of the plurality of sensors 100. In this case, the plurality of sensors 100 may include a plurality of olfactory sensors 100a, at least one temperature sensor 100b, and at least one humidity sensor 100c.

That is, both the temperature sensor 100b and the humidity sensor 100c may be provided singly or be provided in plurality as shown in FIG. 9. FIG. 10 illustrates a case in which a single temperature sensors 100b and a single humidity sensor 100c are provided in the sensor assembly 10b. However, this is exemplary and not limited thereto.

In this case, the sensor assembly 10c may include a plurality of olfactory sensors 100a including different types of sensing materials. In this case, different types of sensing materials may be understood as components for detecting different odor particles.

Referring to FIG. 10, a [1,1] sensor 1111 to a [4,4] sensor 1144 are included in the sensor assembly 10c. In addition, the [1,1] sensor 1111 to the [4,4] sensor 1144 may include one temperature sensor 100b and one humidity sensor 100c. That is, the sensor assembly 10c may include 14 olfactory sensors 100a.

Further, the [1,1] sensor 1111 to the [4,4] sensor 1144 may include a [1,1] sensing material 1211 to a [4,4] sensing material 1244, respectively. In this case, for convenience of understanding, the sensing material for detecting a change in resistance value due to temperature is indicated by a triangle, and the sensing material for detecting a change in resistance value due to humidity is indicated by a square. In addition, the sensing material for detecting a change in resistance value according to smell is indicated by a circle.

Accordingly, the [1, 4] sensing material 1214 may be a sensing material for detecting a change in resistance value according to humidity. In addition, it can be seen that the [4,1] sensing material 1241 corresponds to a sensing material for detecting a change in resistance value according to temperature. That is, the [1,4] sensor 1114 may correspond to the humidity sensor, and the [4,1] sensor 1141 may correspond to the temperature sensor.

In this case, the arrangement of the humidity sensor and the temperature sensor is merely exemplary. That is, the humidity sensor and the temperature sensor may be disposed at different positions. In addition, the number of the humidity sensors and the number of the temperature sensors are exemplary and may be provided in various numbers.

In addition, the remaining sensing materials may be sensing materials for detecting a change in resistance value according to smell. That is, the [1,1] sensor 1111 to [4,4] sensor 1144 except for the [1,4] sensor 1114 and the [4,1] sensor 1141 correspond to an olfactory sensor.

In addition, the [1,1] sensor 1111 to the [4,4] sensor 1144 except for the [1,4] sensor 1114 and the [4,1] sensor 1141 may have different types of sensing materials.

FIG. 10 shows that all olfactory sensors include different types of sensing materials. Accordingly, the sensor assembly 10c may include sensing materials for detecting 14 different types of odor particles.

Referring to FIG. 6, first, output values of the [1,1] sensor 1111, the [1,2] sensor 1112, the [1,3] sensor 1113 and the [1,4] sensor 1114 are detected. Then, the output values of the [2,1] sensor 1121, the [2,2] sensor 1122, the [2,3] sensor 1123 and the [2,4] sensor 1124 are detected. Then, the output values of the [3,1] sensor 1131, the [3,2] sensor 1132, the [3,3] sensor 1133 and the [3,4] sensor 1134 are detected.

Finally, the output values of the [4,1] sensor 1141, the [4,2] sensor 1142, the [4,3] sensor 1143 and the [4,4] sensor 1144 are detected. Then, data corresponding to the output values of the [1,1] sensor 1111 to the [4,4] sensor 1144 is transmitted to the controller 20.

The controller 20 may output the output value of the [1,4] sensor 1114 as a humidity value (C). In addition, the controller 20 may output the output value of the [4,1] sensor 1141 as a temperature value (B).

Then, the controller 20 may calibrate the output values of the [1,1] sensor 1111 to the [4,4] sensor 1144 except for the [1,4] sensor 1114 and the [4,1] sensor 1141, using the output values of the [1,4] sensor 1114 and the [4,1] sensor 1141. The calibrated value may be output as the olfactory value (A).

Also, the controller 20 may analyze a predetermined odor through output values of different types of sensing materials. That is, the controller 20 may discriminate or estimate odor based on values obtained by detecting different odor particles.

In this way, the sensor assembly 10c may output an olfactory value (A), a temperature value (B), and a humidity value (C). In particular, the sensor assembly 10c may derive a more accurate olfactory value (A) through odor particles detected by various types of sensing materials.

In addition, the sensor assembly 10 may include a plurality of olfactory sensors 100a including the same type of sensing material. In addition, a plurality of olfactory sensors 100a including different types of sensing materials may be included in the sensor assembly 10c. When a plurality of olfactory sensors 100a including the same type of sensing material are included, an average value thereof may be selected as an output value.

As described above, the sensor assembly 10 according to the spirit of the present disclosure may include an olfactory sensor, a temperature sensor, and a humidity sensor. In addition, the olfactory sensor, the temperature sensor, or the humidity sensor may be provided in various numbers and arrangements.

1. A sensor assembly comprising:
a plurality of gate lines;
at least one detection line extending to intersect with the plurality of gate lines; and
a plurality of sensors coupled, respectively, to the plurality of gate lines intersect and to the at least one detection line;
wherein the plurality of sensors include
at least one olfactory sensor that each include a first sensing material having a first resistance value that changes according to an odor component;
at least one temperature sensor that each include a second sensing material having a second resistance value that changes according to a change in temperature; and
at least one humidity sensor that each include a third sensing material having a third resistance value that changes according to a change in humidity.

2. The sensor assembly of claim 1, wherein a value detected by the temperature sensor is output as a temperature value,
wherein a value detected by the at least one humidity sensor is output as a humidity value, and
wherein a value detected by the at least one olfactory sensor is calibrated by the value detected by the temperature sensor and the value detected by the at least one humidity sensor to yield an olfactory value.

3. The sensor assembly of claim 1, wherein the plurality of sensors include a plurality of the olfactory sensors, a single temperature sensor and a single humidity sensor.

4. The sensor assembly of claim 1, wherein the plurality of sensors include a plurality of the olfactory sensors, a plurality of the temperature sensors and a plurality of the humidity sensors.

5. The sensor assembly of claim 4, wherein values detected by the plurality of temperature sensors are averaged to be output as a temperature value, and
wherein values detected by the plurality of humidity sensors are averaged to be output as a humidity value.

6. The sensor assembly of claim 1,
wherein the plurality of sensors include a plurality of the olfactory sensors,
wherein the plurality of olfactory sensors each include the first sensing material for detecting an identical type of odor component, and
wherein values detected by the plurality of olfactory sensors are averaged and calibrated with the temperature value and the humidity value to yield as an olfactory value.

7. The sensor assembly of claim 1, wherein the plurality of sensors include a number of the at least one olfactory sensor that is greater than a number of the at least one temperature sensor and the at least one humidity sensor.

8. The sensor assembly of claim 1, wherein each of the plurality of sensors includes a transistor configured to switch a connection between a corresponding one of the first, second, or third sensing materials and the at least one detection line.

9. The sensor assembly of claim 8, further comprising:
a controller configured to transmit a control signal to the plurality of gate lines,
wherein, for each of the plurality of sensors, the transistor connects a corresponding one of the first, second, or third sensing materials and the at least one detection line according to the control signal.

10. The sensor assembly of claim 8, wherein the transistor is a thin film transistor (TFT).

11. The sensor assembly of claim 1, wherein the plurality of gate lines extend in a first direction and are positioned to be spaced apart from each other in a second direction,
wherein the at least one detection line extends in the second direction, and wherein the plurality of sensors are provided in the first direction and the second direction.

12. The sensor assembly of claim 11, wherein a plurality of the detection lines are positioned to be spaced apart from each other in the first direction, and
wherein the plurality of sensors are provided in a matrix form in which the plurality of gate lines intersect with the plurality of detection lines.

13. The sensor assembly of claim 1, wherein the plurality of gate lines include first to n-th gate lines (n is a natural number greater than 1),
wherein the at least one detection line includes a first detection line to an m-th detection line (m is a natural number greater than or equal to 1) and
wherein the plurality of sensors include a [1,1] sensor connected to the first gate line and the first detection line to a [n,m] sensor connected to the n-th gate line and the m-th detection line.

14. The sensor assembly of claim 11, further comprising:
a controller connected to the first to n-th gate lines to sequentially transmit a control signal to the first to n-th gate lines; and
a detector configured to sequentially detect detection values of the plurality of sensors through the first to the m-th detection lines,
wherein the detection values of the [1,1] to the [n,m] sensors are transferred from the detector to the controller.

15. The sensor assembly of claim 1, wherein the plurality of sensors include a plurality of olfactory sensors equipped with a plurality of the third sensing materials for detecting different types of odor components.

16. A method for controlling a sensor assembly including a [1,1] sensor to an [n,m] sensor respectively disposed at intersections of n gate lines (n is a natural number greater than 1) and m detection lines (m is a natural number greater than 1), the method comprising:
changing, by a first sensing material included at least one of the [1,1] sensor to the [n,m] sensor, a first resistance value according to a change in temperature;
changing, by a second sensing material included in at least one of the [1,1] sensor to the [n,m] sensor, a second resistance value according to a change in humidity;
changing, by a third sensing material included in at least one of the [1,1] sensor to the [n,m] sensor, a third resistance value according to a change in an odor component; and
outputting a temperature value, a humidity value, and an olfactory value through reaction values according to the changed first, second, and third resistance values of the first second, and third sensing materials.

17. The method of claim 16, further comprising:
substituting the temperature value into data on a change in the olfactory value for the change in temperature to yield a first calibration value, and performing temperature calibration using the reaction value according to the third resistance value that is changed according to the odor component as the first calibration value;
substituting the humidity value into data on a change in the olfactory value for the change in humidity to yield a second calibration value, and performing humidity calibration using the reaction value according to the third resistance value changed according to the odor component as the second calibration value; and
outputting a value, obtained by performing the temperature calibration and the humidity calibration on the reaction value according to the third resistance value changed according to the odor component, as the olfactory value.

18. The method of claim 16, wherein A is set to 1,
wherein a control signal is transmitted to an A-th gate line,
wherein [A,1] sensing material to [A,m] sensing material respectively included in an [A,1] sensor to an [A,m] sensor connected to the A-th gate line make a reaction such that at least one of the first, second, or third resistance values for the [A,1] sensor to the [A,m] sensor change according to a change in at least one of temperature, humidity, or odor components, and
wherein a corresponding one of the reaction values is transmitted to a first detection line to an m-th detection line respectively connected to the [A,1] sensor to the [A,m] sensor, and
wherein the method further comprises setting A+1 to A, and transmitting a control signal to the A-th gate line until A is greater than n to obtain the reaction values of the [A,1] sensor to the [A,m] sensor.

19. The method of claim 18, further comprising:
sequentially transmitting the control signal to the first to n-th gate lines such that the reaction values are sequentially transmitted the reaction values to the first to m-th detection lines to obtain the reaction values of the [1,1] sensor to the [n,m] sensor.

20. The method of claim 18, further comprising:
suspending transmission of the control signal to the A-th gate line and setting A+1 to A, when the reaction values are transmitted to the first detection line to the m-th detection line respectively connected to the [A,1] sensor to the [A,m] sensor.
